(19) United States
(12) Patent Application Publication
(10) Pub. No.: US 2004/0079491 A1
(43) Pub. Date: Apr. 29, 2004

(54) Evaporative process for the reconstitution of glycol bearing deicing fluids

(76) Inventors: James Jeffrey Harris, Cameron Park, CA (US); James William Harris, Golden, CO (US)

Correspondence Address: James Jeffrey Harris, 2592 Westridge Drive, Cameron Park, CA, 95682, US

(21) Appl. No.: 10/282,167

(22) Filed: Oct. 28, 2002

(51) Int. Cl. B01D 1/14

(52) U.S. Cl. 159/16.1

(57) ABSTRACT

A low temperature process for the dehydration and reconstitution of aqueous diluted glycol bearing deicing fluids using induced airflow (3a,3b,3c) and low temperature thermal sources (4a,4b,4c, 21a,21b,21c) to reduce the water concentration in aqueous diluted glycol bearing deicing fluids (22a,22b,22c). The invention employs the ability for air to vaporize water at low vapor pressures and temperatures in a direct contacting device (5a,5b,5c). The relative vapor pressure of glycol to water at low temperatures assures the preferential vaporization of water rather than glycol, thereby providing dehydration and effective reconstitution of the dilute fluids. The invention further defines a configuration wherein the degree of reconstitution accrues through a sequential series of contacting stages (5a, 5b, 5c). The effect is a net reduction of the glycol vapor pressure, thereby affording improved energy efficiency and reduced glycol carryover.

### BACKGROUND

1. Field of Invention

This invention relates to an evaporative process for the reconstitution of spent, aqueous diluted, primarily glycol based fluids as are employed in the deicing of aircraft. The invention builds upon the glycol regeneration technology developed by the inventor, reference U.S. Pat. No. 5,958,110, with improvements, particularly in application and configuration, to convey proficient reconstitution of spent glycol based aircraft deicing fluids.

2. Description of Prior Art

Deicing fluids have been employed for the removal and/or the suppression of ice formation for many years. The applications for these fluids are numerous. Subsequent to use, these fluids generally collect or drain from the point of application in the form of a spent, substantially ineffective, dilute and often a somewhat solids contaminated aqueous solution. A significant percentage of these spent fluids are discarded via collection and commercial or municipal disposal or they simply are issued to the environment as surface runoff. A fraction of the collected spent fluids have found some limited specialty applications such as raw coal antifreeze and as dust suppression agents. A fraction of the less dilute collected fluids have found some applications as supplemental feedstocks for various industrial chemical processes. Additional applications of the less dilute fluids are found in processing for reuse as antifreeze or similar products.

A common and important role of deicing fluids is for aircraft external surface deicing. In such applications the deicing fluids are generally sparged, as a heated and chemically treated fluid, upon the external surfaces of aircraft. The heating facilitates efficient removal of existing ice and the entrained chemicals provide corrosion inhibition as well as extending some level of residual antifreeze protection to the aircraft surfaces. After use, the solution drains from the aircraft in a dilute state as a result of the requisite snow and ice melt constituent.

The importance of the deicing of aircraft cannot be understated. Ice on aircraft surfaces can be a critical factor in the airworthiness of an aircraft. In consideration of this, the aviation industry has maintained a stringent viewpoint of allowing only virgin deicing fluids for use on aircraft. This constraint has generated difficulties in the employment of these fluids. Historically, since these fluids could not be reused, they generally were discharged to the environment either as surface runoff or via storm water drainage conduits. Environmental considerations have nearly eliminated this practice and generally these dilute or spent deicing fluids are collected. These spent deicing fluids are then handled by a variety of processes. The prevalent processes being disposal through municipal sewerage means and disposal through industrial means such as incineration or treatment to remove the contaminants and provide a recycled fluid for other use. In consideration of the cost of the deicing fluids and the negative environmental impact of the disposal of the spent fluids, the aviation industry is now proceeding carefully with recycling of these spent fluids by means of collection and reconstitution of the spent fluids. Not all of the collected deicing fluids are of sufficient quality to permit reconstitution for reuse. The industry has been actively pursuing other recycle markets for these collected, low quality fluids. The subject invention of this patent provides a means to facilitate said recycling.

Reconstitution of the spent aircraft deicing fluids requires multiple stages of treatment. These stages typically consist of coarse filtration, fine filtration, chemical addition, settling or flotation of solids, membrane separation and/or thermal concentration. In addition to the expense associated with these treatment processes, an additional major expense is associated with the high expenses associated with transporting the dilute spent fluids to the processing facilities. This burden becomes substantially more onerous as the level of dilution increases. The transportation cost is generally one of the major factors inhibiting the recycling of dilute deicing fluid. Unfortunately, such dilute fluids often represent the volumetric majority of the spent deicing fluid collected at most airport deicing sites. Consequently effective methods to concentrate dilute, spent deicing fluids are critically necessary to facilitate cost effective recycling.

The removal of the diluent water is a primary focus in the process for reconstitution of the deicing fluids. The residual glycol and chemical additive concentrations increase as the diluent water is removed. Generally the glycol concentration must reach in excess of 40% to facilitate reuse for deicing. Concurrent with the increase in glycol concentration is an increase in the chemical additive concentration. Once the proper diluent water concentration has been achieved, glycol or chemical additives may be added to assure the proper mix ratios.

Removal of the diluent water from the spent deicing fluids is both the most critical and the most challenging aspect of the reconstitution process. The primary antifreeze characteristics of deicing fluids is imbued by the presence of glycol in the fluid. This glycol however provides challenges for the removal of the diluent water. The separation of diluent water from deicing fluid is usually accomplished through membrane processes and/or vaporization processes. The chemical and physical characteristics of glycol however renders difficulties to both of these processes.

The reader is referenced to the following U.S. patents relating to various membrane predicated techniques of the prior art: U.S. Pat. Nos. 5,034,134, 5,091,081, 5,182,022, 5,194,159, 5,411,668, and U.S. Pat. No. 5,552,023. The small molecular size of glycol limits the potential for membrane separation. Attempts have been made to employ very tight, extremely high pressure membrane processes. These attempts have met with marginal success as a consequence of difficulties primarily associated with high capital and operating expenses. Further, even at the extreme pressures employed by these processes, the glycol concentration level can generally not be brought much above 30-35%. Such concentration levels are insufficient for reliable, cold weather deicing operations.

The employment of membrane processes for the reconstitution of spent deicing fluid have many disadvantages:

(a) To develop reasonably high concentrations of glycol, very small pore, unique membranes are required. These membranes are process specific, not readily available and expensive.

(b) The small pore size of the membranes engenders them to be especially susceptible to fouling and plugging. In consideration of this, substantial expense and effort must be purveyed to assure adequate pretreatment upstream of the membranes. The requisite pretreatment processes are expensive, operationally difficult and prone to failure.

(c) The extremely high pressures required for membrane operation requires very high pressure rated piping, pressure vessels, valves, pumps and instrumentation. This equipment is excessively expensive, unique and of limited availability.

(d) The extremely high pressures required for the membrane process demands high energy consumption. Such energy demand is expensive both from an operational and equipment capital basis.

(e) Chemical treatment is often required to prevent fouling and scaling of the membrane surfaces. These treatment chemicals are expensive, difficult to handle, hazardous to both personnel and the environment and can also deleteriously affect quality of the reconstituted deicing fluid product.

(f) Membrane materials are sensitive to chemical attack. Glycol and some of the chemical additives associated with the deicing fluids can damage the membranes and shorten the expected operating life. The result is increased operating cost and reduced reliability.

Thermal reconstitution of glycol based deicing fluids is the primary method employed in industry as demonstrated in the prior art. This technology employs the application of heat and the resultant vaporization of the aqueous phase from the dilute deicing glycol solution. The method is employed under both atmospheric and vacuum conditions. The reader is referenced to the following U.S. patents relating to various thermally impelled techniques of the prior art: U.S. Pat. Nos. 4,182,659, 5,162,081, 5,904,321 and U.S. Pat. No. 5,928,477. The primary difficulty thermal vaporization encounters in the reconstitution of deicing glycol fluids is a result of glycol evaporative loss and carryover in condensate. This problem is a consequence of the relatively high vapor pressure of glycol at the temperatures normally required for the vaporization of the aqueous phase from the glycol solution. Atmospheric pressure evaporators operate at temperatures in excess of the boiling temperature of water. At these relatively high temperatures, the vapor pressure of glycol is sufficiently elevated to generate a substantial degree of glycol vaporization, thereby affording a substantial loss of glycol from the solution. The glycol vapor is either lost to the atmosphere mixed with the water vapor plume or captured in a condenser as a contaminate of the distilled water condensate. The glycol loss in these processes is unacceptable from an economic, environmental and process viewpoint. To reduce such losses and/or to prevent condensate contamination while further facilitating the provision of evaporative staging, the prior art has demonstrated employment of thermally driven vaporization under sub-atmospheric pressure conditions. In this approach a partial vacuum is held in a boiler as heat is provided to the aqueous glycol solution to impel vaporization. The attribute of the lower temperature is purveyance of a rapid suppression of the glycol vapor pressure relative to that of the water vapor pressure. Accordingly, lower temperature vaporization imbues a reduction of the concentration of glycol vapor relative to water vapor in the thermally generated vapor mixture. The effect being a reduction in the glycol vapor carryover and the ensuing loss of glycol to the environment or contamination of process condensate.

The employment of the thermal vaporization processes for the reconstitution of spent deicing glycol fluids of the prior art has many disadvantages:

(a) Because of the high temperature requirements associated with the thermally driven reconstitution processes for spent deicing glycol based fluids of the prior art, high quality energy is needed. Typically fuel oils, natural gas, coal/coke or electrical energy is employed for operation of the vaporization boilers. The operating costs to fuel these boilers generally are quite high. Further the combustion byproducts from these boilers generally contain environmentally sensitive components for which air pollution permitting and possibly emission offsetting are required. Numerous process refinements have been developed to reduce the energy requirements. Some of these refinements use methods for recapturing and reusing the energy employed in the vaporization process. These methods reduce the thermal energy requirements but do not reduce the temperature requirements of the thermal energy that is used. Even with such refinements, vaporization of the spent deicing glycol based fluid entails the consumption of substantial amounts of high grade thermal energy. This is disadvantageous from economic, operational and environmental standpoints.

(b) The high temperature requirements of the thermally driven reconstitution processes for spent deicing glycol based fluids of the prior art, force the imposition of metallic materials of construction which are expensive, heavy and somewhat difficult to handle. Additionally these materials often must be corrosion resistant: thus necessitating the use of high end alloys and exotic, expensive materials of construction.

(c) The vapor pressure of deicing glycol increases with temperature. At the high boiler operating temperatures associated with the thermally driven deicing glycol based fluid reconstitution processes of the prior art, a significant loss of glycol occurs. This loss is a consequence of the high vapor pressure of glycol in the boiler and the convected loss of said vapor to the environment. This loss purveys both an economic and environmental burden upon operation of the boilers. Replacement cost for the glycol loss is significant. The environmental effects of the glycol emissions may require emission control equipment, an additional capital expense. Further, such emission control equipment is often difficult and expensive to operate. Other expense and operational problems related to environmental concerns are the requirements for additional permitting and/or acquisition of offset permits.

(d) The glycol vapor emissions associated with the thermal reconstitution processes of the prior art, as described in (c) above, are significant at the high operating temperature of the requisite boilers of the prior art, conferring a somewhat unpleasant odor to the local environment. This odor, if not hazardous, is especially a nuisance for which consideration must be given. Placement and operation of the boilers must regard the negative effects of the odor on operating personnel or other nearby human endeavors.

(e) The boilers associated with the thermal reconstitution processes of the prior art are susceptible to scale buildup and fouling of heat exchange and other surfaces. These problems result from impurities in the spent deicing glycol based fluids. These impurities are in the form of suspended particles and/or dissolved solids. As the spent deicing glycol based fluid is heated, there is a tendency for these contaminants to deposit and foul surfaces in the boilers and related systems. The temperature sensitivity of this deposition phenomenon generally results in the preferential fouling of heat exchange surfaces. Operationally this is the worst location for fouling because of the detrimental effects it has upon heat transfer efficiency. To minimize fouling and scaling problems, anti-scalants, dispersants and other chemicals are commonly used. These materials are expensive, often hazardous, environmentally deleterious and potentially can degrade the quality of the reconstituted deicing fluid.

In addition to the temperature induced scale deposition problems inherent to the high temperature operations associated with the thermal reconstitution processes of the prior art, there also is a natural tendency for non-scale precipitates to form on the heat transfer surfaces of the prior art as a result of phase change. Thermal reconstitution generally requires boiling to facilitate a phase change of the spent deicing glycol based fluid to form a vapor. This phase change occurs on the heat transfer surfaces generally in a boiler. As the phase change occurs, dissolved or suspended solids precipitate from the solution at the point of vaporization. As previously mentioned, this is the most inopportune location for fouling because of detrimental effects upon heat transfer efficiency.

(f) In order to reduce the scaling, fouling and precipitate formation problems inherent in the high temperature boilers associated with the thermal reconstitution processes of the prior art, chemical treatment of spent deicing glycol based fluid upstream of the boiler is common. These chemicals are expensive, hazardous and present a potential for degrading the quality of the reconstituted deicing fluid.

(g) Reconstituted deicing glycol based fluid from the boilers associated with the thermal reconstitution processes of the prior art is a high temperature glycol based fluid which often must be cooled prior to use or storage. This is accomplished either through a heat exchanger for thermal reuse in the boiler or a separate cooling system. Accordingly the required equipment adds a significant capital cost to the reconstitution process. Also heat exchangers and/or cooling systems are vulnerable to scaling, fouling and operational difficulties.

(h) A major disadvantage with the prior art relates to the practice of vaporizing the aqueous phase from a solution containing a deicing glycol concentration equivalent to that as require for the reconstituted product. This practice results in excess energy consumption, glycol loss and environmental risk. Deicing glycol based fluid reconstitution boilers of the prior art typically operate with the vaporizing fluid at near the deicing glycol concentration required for the product. In such operations the fluid is brought to a boil wherein the aqueous phase is vaporized off. The vaporization temperature rises as the deicing glycol concentration rises. Upon reaching the required concentration level, blow-down is initiated and the concentration and temperature remain constant as concentrate blow-down and dilute glycol based fluid are fed in balance to maintain the requisite concentration. The glycol vapor pressure increases with the solution temperature. As the glycol vapor pressure increases the aqueous vapor pressure is suppressed. This effect results in higher thermal energy requirements for vaporization of the aqueous phase. Further, higher glycol vapor pressures correspond to a higher glycol vapor concentration in the steam discharge plume. This high glycol concentration engenders substantial glycol loss and air pollution hazards.

### OBJECTS AND ADVANTAGES

This invention relates to a low temperature, essentially atmospheric pressure thermal process whereby an air induced, evaporative means is employed to reconstitute spent deicing glycol based fluid. The advantages of the invention result primarily from the ability of the invention to reconstitute the spent deicing glycol based fluids using inexpensive, low grade heat, without the necessity for high pressure pumps, membranes or boilers.

The low temperature and low pressure operating capability of the invention as well as other features provides several objects and advantages over the prior art. Some of which are as follows:

(a) Because of the low operating temperature, high grade (high temperature) heat is not required. This is a great advantage in the provision that waste heat can be used as a thermal source. Waste heat is traditionally discarded to the environment as having no economic or process value. The invention can employ this wasted thermal energy for the useful purpose of reconstituting spent deicing glycol based fluids. The ability to use this free thermal energy source eliminates the cost of fuel typically associated with operation of a boiler. As a consequence, the economic and process benefits are substantial.

(b) Since waste heat can be utilized in lieu of combustion fuels, environmental emissions of fuel combustion products can be reduced or eliminated. In addition to environmental benefits, this can reduce or eliminate permitting costs, siting constraints, as well as operating difficulties, costs and scheduling.

(c) Since the invention can operate at temperatures within the operational limits of inexpensive plastics, these materials can be used for fabrication of the spent deicing glycol based fluid reconstitution equipment. This reduces the cost of the regeneration equipment and makes it lighter, easier to maintain and, as is often a high priority, corrosion resistant.

(d) The vapor pressure of the glycol constituent of deicing glycol based fluids is dependent upon temperature. At the lower operating temperatures of the invention, the glycol vapor pressures are significantly reduced. As a result, glycol losses during reconstitution are minimized. Further, glycol carryover in vapor emissions or condensate are minimized. This is a significant economic, operational, environmental, siting and permitting advantage.

(e) The low vaporization temperature of the invention and the resultant lower vapor pressure of the glycol constituent of the deicing glycol based fluid results in reduced glycol loss to the environment. The sickly sweet odor of emitted glycol is thereby substantially eliminated. The operating and living environs are therefore made more pleasant and healthier for operating or other affected personnel.

(f) The low vaporization temperature of the invention minimizes the tendency for fouling and scaling of heat exchange and other surfaces. The lower operating temperature of the invention reduces the operating difficulties produced by temperature induced scaling and fouling. Such effects occur as a consequence of contamination of the spent deicing glycol based fluids with dissolved and suspended solids which show a proclivity toward thermally induced fouling and scaling deposition.

(g) The vaporization process of the diluent aqueous phase of the spent deicing glycol based fluid occurs physically separate from the heat transfer process. As a result, any precipitates which form will not foul or damage the heat transfer surfaces or other process contacted surfaces.

(h) The reduced fouling and scaling tendencies purveyed by the lower vaporization temperature of the invention, minimizes the requirements for chemical pretreatment of the spent deicing glycol based fluid. This advantage imbues the invention with a substantial reduction in capital and operating expenses relative to that of the prior art.

(I) The low temperature vaporization capability of the invention minimizes heat transfer requirements for cooling of the reconstituted deicing glycol based fluid. This reduces capital and operating expenses over that which would otherwise be required if the high temperature vaporization processes of the prior art were employed.

(j) The ability of the invention to use low temperature heat provides the opportunity to use waste heat as a thermal source. Typically waste heat is a byproduct of an exothermic process from which heat must be removed to facilitate process continuation. Cooling equipment provided to disseminate this waste heat, is therefore an integral part of the process system. The invention can confer cooling service concurrent with reconstitution of spent deicing glycol based fluids. This advantage affords a reduction or elimination of cooling system capital and operational expenses. For those processes which utilize evaporative cooling, an additional benefit resulting from the use of the invention for cooling, is in the reduction or elimination of liabilities inherent with the blowdown of coolant to the environment.

(k) The embodiment of the invention in a sequentially staged configuration affords reduced thermal and airflow requirements. Further, this configuration minimizes deicing glycol carryover and potential air emissions. This embodiment of invention operates as a sequential series of smaller aqueous phase vaporization units wherein each unit provides a fractional share of the required overall reconstitution effect. In this manner, with the exception of the first unit which is fed the raw dilute deicing glycol based fluid, each vaporization unit is fed the partially reconstituted product from the previous unit. The overall effect is a net reduction of the deicing glycol concentration in contact with the vaporizing aqueous phase. As a result, the overall net thermal requirements, both in energy and temperature, are reduced. Further the required airflow and associated capital and operating costs are reduced. Additionally deicing glycol carryover is minimized thereby preventing economic loss and minimizing environmental risk.

(l) The sequentially staged embodiment of the invention affords vaporization of the majority of the aqueous phase from the deicing glycol based fluid at deicing glycol and additive chemical concentrations substantially less than the required final reconstitution concentration. As a consequence fouling, scaling, plugging and solids precipitation difficulties associated with high concentration levels are substantially reduced. Further advantages resulting from this benefit being reduced anti-scaling or dispersant chemical usage and expense, reduced cleaning maintenance downtime and expense as well as extended equipment life.

### DRAWING FIGURES

FIG. 1 is a process diagram of a single stage embodiment of the invention.

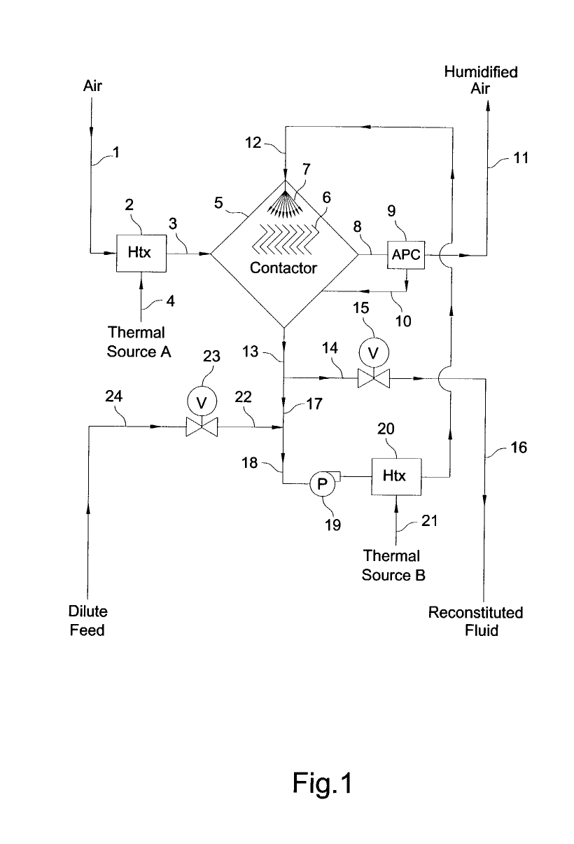

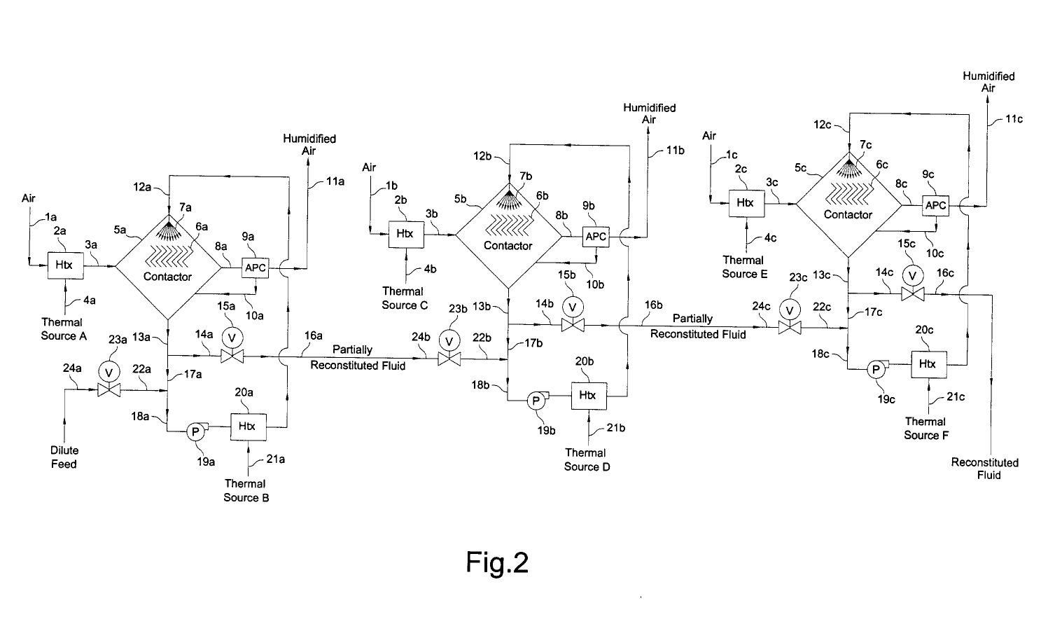

### REFERENCE NUMERALS IN FIG. 1

1 Airstream induced through the invention

2 Airstream heat exchanger (Optional if the spent deicing glycol based fluid heat exchanger, item #18, is utilized)

3 Contactor airstream (will be heated to above inlet airstream wet bulb temperature if item #2 is in use)

4 Thermal source to item #2 (Thermal source temperature must be higher than the inlet airstream wet bulb temperature)

5 Contactor

6 Contacting surface media (Optional to enhance performance of the distribution system, item #7)

7 Distribution or sparger system

8 Humidified Airflow

9 Air pollution control device (Optional)

10 Air pollution drain back to process (Optional)

11 Humidified air to discharge

12 Spent, dilute deicing glycol based fluid inlet the contactor (Heated to above the contactor airstream wet bulb temperature, if heat exchanger #18 is utilized)

13 Reconstituted deicing glycol based fluid

14 Bleed or blowdown of reconstituted deicing fluid as a product or for further treatment

15 Reconstituted deicing fluid bleed control valve or mechanism

16 Reconstituted deicing fluid product or feed for further treatment

17 Circulating reconstituted deicing fluid remaining after #14 is bled from #13

18 Mixture of reconstituted deicing fluid from the contactor and spent, dilute deicing fluid feed

19 Circulating pump

20 Deicing fluid heat exchanger (Optional if item #2 is utilized)

21 Thermal source for the Deicing fluid heat exchanger item #20 (Temperature must be higher than the contactor airstream wet bulb temperature)

22 Inlet for spent, dilute deicing fluid

23 Inlet valve or mechanism to control the spent deicing fluid feed

24 Spent deicing fluid feed

FIG. 1 is a process diagram of a single stage embodiment of the invention.

### REFERENCE NUMERALS IN FIG. 2

1a Airstream induced through the first stage of the invention

1b Airstream induced through the second stage of the invention

1c Airstream induced through the third stage of the invention

2a First stage airstream heat exchanger (Optional if the spent deicing fluid heat exchanger, item #18a, is utilized)

2b Second stage airstream heat exchanger (Optional if the spent deicing fluid heat exchanger, item #18b, is utilized)

2c Third stage airstream heat exchanger (Optional if the spent deicing fluid heat exchanger, item #18c, is utilized)

3a Contactor airstream of the first stage (will be heated to above inlet airstream wet bulb temperature if item #2a is in use)

3b Contactor airstream of the second stage (will be heated to above inlet airstream wet bulb temperature if item #2b is in use)

3c Contactor airstream of the third stage (will be heated to above inlet airstream wet bulb temperature if item #2c is in use)

4a Thermal source to item #2a (Thermal source temperature must be higher than the inlet airstream wet bulb temperature of the first stage)

4b Thermal source to item #2b (Thermal source temperature must be higher than the inlet airstream wet bulb temperature of the second stage)

4c Thermal source to item #2c (Thermal source temperature must be higher than the inlet airstream wet bulb temperature of the third stage)

5a Contactor for the first stage

5b Contactor for the second stage

5c Contactor for the third stage

6a Contacting surface media of the first stage (Optional to enhance performance of the distribution system, item #7a)

6b Contacting surface media of the second stage (Optional to enhance performance of the distribution system, item #7b)

6c Contacting surface media of the third stage (Optional to enhance performance of the distribution system, item #7c)

7a Distribution or sparger system of the first stage

7b Distribution or sparger system of the second stage

7c Distribution or sparger system of the third stage

8a Humidified airflow of the first stage

8b Humidified airflow of the second stage

8c Humidified airflow of the third stage

9a Air pollution control device of the first stage (Optional)

9b Air pollution control device of the second stage (Optional)

9c Air pollution control device of the third stage (Optional)

10a First stage air pollution drain back to process (Optional)

10b Second stage air pollution drain back to process (Optional)

10c Third stage air pollution drain back to process (Optional)

11a Humidified air to discharge from the first stage

11b Humidified air to discharge from the second stage

11c Humidified air to discharge from the third stage

12a In the first stage; the spent, dilute deicing fluid inlet to the contactor (Heated to above the contactor airstream wet bulb temperature, if heat exchanger #18a is utilized)

12b In the second stage; the spent, dilute deicing fluid inlet to the contactor (Heated to above the contactor airstream wet bulb temperature, if heat exchanger #18b is utilized)

12c In the third stage; the spent, dilute deicing fluid inlet to the contactor (Heated to above the contactor airstream wet bulb temperature, if heat exchanger #18c is utilized)

13a Reconstituted deicing fluid after the first stage contactor

13b Reconstituted deicing fluid after the second stage contactor

13c Reconstituted deicing fluid after the third stage contactor

14a Bleed or blowdown from 13a of reconstituted deicing fluid in the first stage

14b Bleed or blowdown from 13b of reconstituted deicing fluid in the second stage

14c Bleed or blowdown from 13c of reconstituted deicing fluid in the third stage

15a Reconstituted deicing fluid bleed control valve or mechanism in the first stage

15b Reconstituted deicing fluid bleed control valve or mechanism in the second stage

15c Reconstituted deicing fluid bleed control valve or mechanism in the third stage

16a Partially reconstituted deicing fluid product from the first stage as feed to the second stage

16b Partially reconstituted deicing fluid product from the second stage as feed to the third stage

16c Reconstituted deicing fluid product from the third stage as product

17a Circulating partially reconstituted deicing fluid in the first stage remaining after #14a is bled from #13a

17b Circulating partially reconstituted deicing fluid in the second stage remaining after #14b is bled from #13b

17c Circulating reconstituted deicing fluid in the third stage remaining after #14c is bled from #13c

18a Mixture of partially reconstituted deicing fluid in the first stage from the contactor and spent, dilute deicing fluid feed to the first stage

18b Mixture of partially reconstituted deicing fluid in the second stage from the contactor and partially reconstituted deicing fluid product from the first stage

18c Mixture of reconstituted deicing fluid in the third stage from the contactor and partially reconstituted deicing fluid product from the second stage

19a Circulating pump of the first stage

19b Circulating pump of the second stage

19c Circulating pump of the third stage

20a First stage deicing fluid heat exchanger (Optional if item #2a is utilized)

20b Second stage deicing fluid heat exchanger (Optional if item #2b is utilized)

20c Third stage deicing fluid heat exchanger (Optional if item #2c is utilized)

21a Thermal heat supplied to the deicing fluid heat exchanger of the first stage item #20a (Temperature must be higher than the first stage contactor airstream wet bulb temperature)

21b Thermal heat supplied to the deicing fluid heat exchanger of the second stage item #20b (Temperature must be higher than the second stage contactor airstream wet bulb temperature)

21c Thermal heat supplied to the deicing fluid heat exchanger of the third stage item #20c (Temperature must be higher than the third stage contactor airstream wet bulb temperature)

22a Inlet port in the first stage for spent, dilute deicing fluid

22b Inlet port in the second stage for partially reconstituted deicing fluid product from the first stage

22c Inlet port in the third stage for partially reconstituted deicing fluid product from the second stage

23a Inlet valve or mechanism to control the spent deicing fluid feed into the first stage

23b Inlet valve or mechanism to control feed of the partially reconstituted deicing fluid product from the first stage into the second stage

23c Inlet valve or mechanism to control feed of the partially reconstituted deicing fluid product from the second stage into the third stage

24a Spent deicing fluid feed into the first stage

### BRIEF SUMMARY OF THE INVENTION

The intent of this patent is to describe a low temperature thermal process and a mechanism for the reconstitution of spent, dilute, glycol based deicing fluids, especially those associated with aircraft deicing. The process incorporates the introduction of an airstream into direct contact with a dilute deicing fluid. The provided airstream conveys the equilibrium water vapor away from the dilute deicing fluid. Said conveyance maintains a low water vapor concentration at the air to dilute deicing fluid interface. The low water vapor concentration generates a low water vapor partial pressure which affords the conditions for low temperature vaporization. At the reduced vapor pressure, the interfacial water vapor and the aqueous phase of the dilute deicing solution are not in thermodynamic equilibrium. To re-establish the natural requirements for thermodynamic equilibrium, water vaporizes at a low temperature from the aqueous phase and passes through the interface to replace the water vapor removed by the airstream. The vaporization of the water vapor away from the interface and subsequent conveyance by the airstream results in the dehydration and reconstitution of the deicing fluid. The transference of the water from the aqueous phase to the vapor phase requires thermal energy. This energy is supplied and carried to the process from either the liquid phase of the dilute deicing fluid and/or the contacting airstream. To maintain the continued reconstitution process, thermal energy is supplied continuously to either to the contacting airstream or to the dilute deicing fluid. The temperature of the required thermal energy is low.

A preferred embodiment of the invention is defined wherein the reconstitution process, as described in the foregoing, is facilitated in a sequential series of stages. In such a sequential configuration, with the exception of the first stage, which receives the dilute deicing fluid, the inlet fluid entering each stage is the partially reconstituted product from the previous stage. Accordingly, the fully reconstituted product is provided only by the last stage. As a consequence of such a configuration, the vaporization of the diluent water occurs in stages wherein each sequential stage operates at increased concentrations of deicing glycol as well as residual chemical additives. In this superior embodiment, all but the last stage operate at deicing glycol concentrations less than the final targeted concentration. The net effect of this embodiment being the overall reduction of the deicing glycol and other residual chemical concentrations present during evaporation of the aqueous phase. The benefits therein affording a substantial reduction of the required thermal energy, operating temperature, airflow, glycol and chemical carryover as well as reduction of the scaling, plugging and fouling problems associated with aqueous phase vaporization at elevated concentrations.

### DESCRIPTION—FIG. 1

Direct to obtaining the effect of the invention a typical embodiment is illustrated on FIG. 1 and is described in the following discussion. Air 1 is brought through an optional heat exchanger 2 which, if utilized, transfers thermal energy 4, from thermal source A, into the airstream 1. The airstream 3 is directed into a contacting chamber 5, referred hereafter as the contactor, wherein the airstream 3 enters into direct contact with dilute deicing fluid 12 which has been optionally supplied thermal energy from source B by means of heat exchanger 20. Said direct contact may be brought about by a plurality of means. The dilute deicing fluid 12 may be sparged 7 into the airstream 3 and/or distributed over a contacting media 6 through which the airstream 3 passes. Said contacting media 6 provides increased contact time between the airstream 3 and the dilute deicing fluid 12 as well as may provide increased interfacial area for contact. The use of contact media 6 in combination with, or in lieu of, a sparger system 7, may expedite thermal and mass transfer rates which will enhance the performance and reduce the overall physical dimensions of the contactor 5 and associated equipment.

As the airstream 3 passes through the contactor, water is transferred as a liquid from the dilute deicing fluid 12 into the airstream 3 as a vapor. The water vapor is then conveyed with the now humidified airstream 8 out and away from the contactor 5. The effect is to dehydrate and thereby reconstitute the dilute deicing fluid 12. Dependent upon environmental constraints as well as performance characteristics of the contactor 5, sparger 7 and/or contacting media 6, the airstream 8 may be directed through an air pollution control device 9 to remove mist or droplets of deicing fluid entrained within the airstream 8. Fluids collected by the air pollution control device 9 can either be discarded, used for some other purpose or, as in this embodiment, returned to the invention for processing 10.

After contacting the airstream 3, the dehydrated deicing fluid 13 is removed from the contactor. A portion 14 or, under the unique conditions of high thermal source A and/or B temperatures and/or a low aqueous dilution of the spent deicing fluid feed, all of the reconstituted deicing fluid, is removed from the process through a bleed control mechanism 15. The bleed is then discharged 16 as reconstituted product for use, storage or further treatment.

The dilute deicing fluid to be reconstituted 24 is fed into the process through the inlet control mechanism 23. The feed volume 22 is controlled to balance the sum of the bled volume 16 and the liquid equivalent volume of water vaporized from the dilute deicing fluid 12 in the contactor 5 and discharged within the humidified airstream 11. The dilute feed volume 22 is blended with the dehydrated deicing fluid 17 remaining after the bleed. The blended fluid 18 is pressurized through circulating pump 19. If heat exchanger 20 is employed, thermal energy 21, as provided by thermal source B is transferred into the blended fluid 18. The blended and dilute deicing fluid 12 is then returned to the contactor 5 and the process is repeated.

The process of the invention employs thermal energy at low temperatures. As described above, the thermal energy may be supplied to the process either through heat transfer 4 into the airstream 1 at heat exchanger 2 and/or through heat transfer 21 into the blended deicing fluid 18 at heat exchanger 20. The option as to where the thermal energy is supplied is determined by the characteristics and availability of the thermal sources A and B.

### DESCRIPTION—FIG. 2

As a further embodiment cited for the purposes of reducing carryover and/or improving energy efficiency, a multi-staged series configuration of the invention is illustrated on FIG. 2. In such an embodiment, reconstitution of the deicing fluid occurs sequentially in a plurality of stages, each stage being individual embodiments corresponding to that as illustrated and discussed relative to FIG. 1. FIG. 2 demonstrates a three stage example of such a sequentially staged embodiment of the invention. Such an embodiment should not be construed as limited to the three stages as illustrated on FIG. 2. The three stage embodiment as illustrated by FIG. 2 is included to simply purvey an example of a sequentially staged embodiment of the art.

As illustrated on FIG. 2, the spent, dilute deicing fluid 24a is fed to the first stage of the process. Air 1a is brought through an optional heat exchanger 2a which, if utilized, transfers thermal energy 4a, from an external source A, into the airstream 1a. The airstream 3a is directed into a contacting chamber 5a, referred hereafter as the contactor, wherein the airstream 3a enters into direct contact with dilute deicing fluid 12a which has been optionally supplied thermal energy from source B by means of heat exchanger 20a. Said direct contact may be brought about by a plurality of means. The dilute deicing fluid 12a may be sparged 7a into the airstream 3a and/or distributed over a contacting media 6a through which the airstream 3a passes. Said contacting media 6a provides increased contact time between the airstream 3a and the dilute deicing fluid 12a as well as may provide increased interfacial area for contact. The use of contact media 6a in combination with, or in lieu of, a sparger system 7a, may expedite thermal and mass transfer rates which will enhance the performance and reduce the overall physical dimensions of the contactor 5a and associated equipment.

As the airstream 1a passes through the contactor 5a, water is transferred as a liquid from the dilute deicing fluid 12a into the airstream 3a as a vapor. The water vapor is then conveyed with the now humidified airstream 8a out and away from the contactor 5a. The effect is to dehydrate and thereby reconstitute the dilute deicing fluid 12a. Dependent upon environmental constraints as well as performance characteristics of the contactor 5a, sparger 7a and/or contacting media 6a, the airstream 8a may be directed through an air pollution control device 9a to remove mist or droplets of deicing fluid entrained within the airstream 8a. Fluids collected by the air pollution control device 9a can either be discarded, used for some other purpose or, as in this embodiment, returned to the invention for processing 10a.

After contacting the airstream 3a, the dehydrated deicing fluid 13a is removed from the contactor 5a. A portion 14a or, under the unique conditions of high thermal source temperatures A or B and/or a low aqueous dilution of the spent deicing fluid feed 24a, all of the reconstituted deicing fluid, is removed from the process through a bleed control mechanism 15a. The bleed is then discharged 16a as partially reconstituted product for further treatment in second stage of the embodiment.

The dilute deicing fluid 24a is fed into the process through the inlet control mechanism 23a. The feed volume 22a is controlled to balance the sum of the bleed volume 16a and the liquid equivalent volume of water vaporized from the dilute deicing fluid 12a in the contactor 5a and discharged within the humidified airstream 11a. The dilute feed volume 22a is blended with the dehydrated deicing fluid 17a remaining after the bleed. The blended fluid 18a is pressurized through circulating pump 19a. If heat exchanger 20a is employed, thermal energy 21a, provided by thermal source B is transferred into the blended fluid 18a. The blended and dilute deicing fluid 12a is then returned to the contactor 5a and the process is repeated.

The process of the invention employs thermal energy at low temperatures. As described above, the thermal energy may be supplied to the first stage of this embodiment either through heat transfer 4a into the airstream 1a at heat exchanger 2a and/or through heat transfer 21a into the blended deicing fluid 18a at heat exchanger 20a. The option as to where the thermal energy is supplied is determined by the characteristics and availability of the thermal sources A and B.

Partially reconstituted deicing fluid 16a exits from the first stage and is directed as the inlet feed for the second stage of the sequential process. Air 1b is brought through an optional heat exchanger 2b which, if utilized, transfers thermal energy 4b, from an external source C, into the airstream 1b. The airstream 3b is directed into a contacting chamber 5b, wherein the airstream 3b enters into direct contact with dilute deicing fluid 12b which has been optionally supplied thermal energy from source D by means of heat exchanger 20b. Said direct contact may be brought about by a plurality of means. The dilute deicing fluid 12b may be sparged 7b into the airstream 3b and/or distributed over a contacting media 6b through which the airstream 3b passes. Said contacting media 6b provides increased contact time between the airstream 3b and the dilute deicing fluid 12b as well as may provide increased interfacial area for contact. The use of contact media 6b in combination with, or in lieu of, a sparger system 7b, may expedite thermal and mass transfer rates which will enhance the performance and reduce the overall physical dimensions of the contactor 5b and associated equipment.

As the airstream 1b passes through the contactor 5b, water is transferred as a liquid from the dilute deicing fluid 12b into the airstream 3b as a vapor. The water vapor is then conveyed with the now humidified airstream 8b out and away from the contactor 5b. The effect is to dehydrate and thereby reconstitute the dilute deicing fluid 12b. Dependent upon environmental constraints as well as performance characteristics of the contactor 5b, sparger 7b and/or contacting media 6b, the airstream 8b may be directed through an air pollution control device 9b to remove mist or droplets of deicing fluid entrained within the airstream 8b. Fluids collected by the air pollution control device 9b can either be discarded, used for some other purpose or, as in this embodiment, returned to the invention for processing 10b.

After contacting the airstream 3b, the dehydrated deicing fluid 13b is removed from the contactor 5b. A portion 14b or, under the unique conditions of high thermal source temperatures C or D and/or a low aqueous dilution of the spent deicing fluid feed 24b, all of the reconstituted deicing fluid, is removed from the process through a bleed control mechanism 15b. The bleed is then discharged 16b as a partially reconstituted product for further treatment in the third stage of the embodiment.

The partially reconstituted deicing fluid 16a from the first stage is fed into the second stage through the inlet control mechanism 23b. The feed volume 22b is controlled to balance the sum of the bleed volume 16b and the liquid equivalent volume of water vaporized from the dilute deicing fluid 12b in the contactor 5b and discharged within the humidified airstream 1b. The dilute feed volume 22b is blended with the dehydrated deicing fluid 17b remaining after the bleed. The blended fluid 18b is pressurized through circulating pump 19b. If heat exchanger 20b is employed, thermal energy 21b, provided by thermal source D is transferred into the blended fluid 18b. The blended and dilute deicing fluid 12b is then returned to the contactor 5b and the process is repeated.

The process of the invention employs thermal energy at low temperatures. As described above, the thermal energy may be supplied to the second stage of the embodiment either through heat transfer 4b into the airstream 1b at heat exchanger 2b and/or through heat transfer 21b into the blended deicing fluid 18b at heat exchanger 20b. The option as to where the thermal energy is supplied is determined by the characteristics and availability of the thermal sources C and D.

Partially reconstituted deicing fluid 16b exits from the second stage and is directed as the inlet feed for the third stage of the sequential process. Air 1c is brought through an optional heat exchanger 2c which, if utilized, transfers thermal energy 4c, from an external source E, into the airstream 1c. The airstream 3c is directed into a contacting chamber 5c, wherein the airstream 3c enters into direct contact with dilute deicing fluid 12c which has been optionally supplied thermal energy from source F by means of heat exchanger 20c. Said direct contact may be brought about by a plurality of means. The dilute deicing fluid 12c may be sparged 7c into the airstream 3c and/or distributed over a contacting media 6c through which the airstream 3c passes. Said contacting media 6c provides increased contact time between the airstream 3c and the dilute deicing fluid 12c as well as may provide increased interfacial area for contact. The use of contact media 6c in combination with, or in lieu of, a sparger system 7c, may expedite thermal and mass transfer rates which will enhance the performance and reduce the overall physical dimensions of the contactor 5c and associated equipment.

As the airstream 1c passes through the contactor 5c, water is transferred as a liquid from the dilute deicing fluid 12c into the airstream 3c as a vapor. The water vapor is then conveyed with the now humidified airstream 8c out and away from the contactor 5c. The effect is to dehydrate and thereby reconstitute the dilute deicing fluid 12c. Dependent upon environmental constraints as well as performance characteristics of the contactor 5c, sparger 7c and/or contacting media 6c, the airstream 8c may be directed through an air pollution control device 9c to remove mist or droplets of deicing fluid entrained within the airstream 8c. Fluids collected by the air pollution control device 9c can either be discarded, used for some other purpose or, as in this embodiment, returned to the invention for processing 10c.

After contacting the airstream 3c, the dehydrated deicing fluid 13c is removed from the contactor 5c. A portion 14c or, under the unique conditions of high thermal source temperatures E or F and/or a low aqueous dilution of the spent deicing fluid feed 24c, all of the reconstituted deicing fluid, is removed from the process through a bleed control mechanism 15c. The bleed is then discharged 16c as a reconstituted product for use, storage or further treatment.

The partially reconstituted deicing fluid 16b from the second stage is fed into the third stage through the inlet control mechanism 23c. The feed volume 22c is controlled to balance the sum of the bleed volume 16c and the liquid equivalent volume of water vaporized from the dilute deicing fluid 12c in the contactor 5c and discharged within the humidified airstream 11c. The dilute feed volume 22c is blended with the dehydrated deicing fluid 17c remaining after the bleed. The blended fluid 18c is pressurized through circulating pump 19c. If heat exchanger 20c is employed, thermal energy 21c, provided by thermal source F is transferred into the blended fluid 18c. The blended and dilute deicing fluid 12c is then introduced to the contactor 5c and the process is repeated.

The process of the invention employs thermal energy at low temperatures. As described above the thermal energy may be supplied to the process either through heat transfer 4c into the airstream 1c at heat exchanger 2c and/or through heat transfer 21c into the blended deicing fluid 18c at heat exchanger 20c. The option as to where the thermal energy is supplied is determined by the characteristics and availability of the thermal sources E and F.

### Conclusion, Ramifications, and Scope

The reader will see that the invention provides a low temperature, thermally driven process for the reconstitution of deicing fluids. The advantages over prior processes are substantial in that low temperature heat may be used. This permits the use of waste heat. This capability to utilize waste heat provides the invention with the additional opportunity to service other, separate, processes which require cooling. For those situations where waste heat is available but for which cooling services are not required, as in heat entrained in stack or flue gas, the invention permits the use of essentially free heat for the reconstitution process. This capability provides a significant economic and environmental advantage over conventional thermal reconstitution processes which require the consumption of fuel or electricity. The reader will also see that the staged embodiment of the invention provides many and substantial benefits over the methods and means of the prior art. Reduced energy use, reduced deicing fluid additives and glycol loss, reduced emissions to the environment as well as reduced equipment capital costs are but a few of the advantages and benefits. There are many other inherent benefits and advantages to the invention. Some of these additional advantages are:

The low temperature operating capability of the invention is advantageous in facilitating the employment of lightweight, inexpensive and easy to fabricate, high temperature sensitive materials, such as plastics for construction. These materials also generally provide excellent corrosion resistance.

The low operating temperature of the invention dramatically reduces deicing glycol evaporative losses. This effect reduces operating costs, improves the operating environment due to reduced odors, and reduces environmental liabilities resulting from deicing glycol and other additive chemical emissions.

The low operating temperature of the invention minimizes detrimental effects which can be caused by high temperatures. High temperature induced difficulties such as scaling and fouling of heat exchangers and other equipment can be minimized.

As a result of the reduced tendency toward fouling and scaling at lower operating temperatures, operating costs through the reduction of anti-scaling and dispersent chemical treatment costs as well as maintenance costs related to descaling and cleaning are reduced.

The low operating temperature of the invention minimizes chemical and mineral precipitation problems associated with fouling and scaling. As a result, blowdown and makeup volumes can be reduced, thereby minimizing operating costs and environmental liabilities.

Reduced tendencies toward scaling, fouling, chemical and mineral precipitation minimize requirements for treatment of the deicing fluids prior to and during reconstitution. The result is reduced capital and operating expenses.

The lowered operating temperatures reduces or eliminates cooling requirements in temperature sensitive processes for which the reconstituted glycol fluids must not be hot.

The lowered operating temperatures reduces or eliminates thermal damage to chemical additives prone to thermal degradation.

The sequentially staged embodiment of the invention reduces the required thermal energy for reconstitution dramatically, thereby reducing operating expenses as well as potentially reducing environmental pollution associated with the generation of thermal energy.

Sequential staging reduces deicing glycol and other additive emissions to a minimum thereby providing an environmentally friendly deicing fluid reconstitution process.

The sequential staging of the invention provides the means to reduce the airflow requirement and therefore operating expense, capital expense, physical size and operating sound level.

Sequential staging facilitates the reconstitution of deicing fluids at generally lower temperatures and chemical concentrations thereby minimizing fouling, plugging or scaling brought about by reconstitution at high concentrations and/or temperatures.

While the foregoing discussions specify the many advantages inherent to the invention these do not constitute the full scope of the advantages therein. The knowledgeable reader will certainly note that there are many other advantages beyond and above the scope as defined in the foregoing. In a similar manner the embodiment described in the foregoing also is not the only embodiment possible. Many other embodiments are feasible.

The discussion in the foregoing has focused the invention toward the reconstitution of spent aircraft deicing fluids. The primary constituent of aircraft deicing fluids are glycols. The invention should certainly not be construed as being limited to applications only involved with the reconstitution of aircraft deicing fluids. There are many other conceivable applications wherein the invention can be successfully employed to reconstitute or dehydrate glycol based solutions for other aspect of industry. Some examples of such applications are in recycling or reconcentrating glycol based antifreeze solutions. Another example would be for the regeneration of dessicant glycol solutions commonly employed in the petroleum industry. These represent only a few of the other possible applications for the invention. The knowledgeable reader would certainly be aware of the many different glycol based industrial applications in which the invention would be of substantial benefit.

An embodiment whereby a different gas, other than airstream 1, 1a, 1b and/or 1c could be used with similar effects. Reconstitution effects could also be varied through changes in the pressure of airstream 1, 1a, 1b, 1c or other gas. The heat exchanger 2, 2a, 2b and/or 2c supplies thermal energy to the airstream 1, 1a, 1b and/or 1c. This airstream itself may supply part or all of the thermal energy into the contactor 5, 5a, 5b and/or 5c. If the pyschrometric conditions of the airstream into the contactor are such that evaporative cooling effects occur in the contactor, the thermal energy released through the cooling of the airstream can supplement or fulfill the thermal requirements of the invention. Under this scenario the overall thermal energy requirements of the invention are reduced.

In the presented embodiment the contactor 5, 5a, 5b and/or 5c has been inferred as being a structure which provides the environment necessary to contact the airstream 3, 3a, 3b, and/or 3c with the dilute deicing glycol solution 12, 12a, 12b and/or 12c. The physical nature of this structure may take a plurality of forms from a simple duct structure to more complex multi-chamber designs with control vanes and baffles for control flow patterns. Another possible embodiment would not require a contacting structure at all. In this embodiment an external lake, pond or pool as collection sump with a sparge system and or contacting media above this sump could be utilized. The airstream 3, 3a, 3b and/or 3c could then be artificially induced or natural wind patterns utilized.

The air pollution control device 9, 9a, 9b and/or 9c may or may not be necessary depending upon environmental constraints as well as contactor 5, 5a, 5b and/or 5c and sparger 7, 7a, 7b and/or 7c contacting media 6, 6a, 6b and/or 6c specifications. If necessary the air pollution control device can be many different types of devices. Devices as simple as quiescent settling chambers or as sophisticated as electrostatic precipitators may be utilized. A possible configuration could include heat and/or mass transfer capabilities in the air pollution control device or in lieu of the air pollution control device to extract the latent heat of evaporation from the humidified airstream 11, 11a, 11b and/or 11c. The effects of this would be to recycle heat back into the process or to collect the resultant condensate. This condensate could be utilized as a fresh water source.

The reconstituted deicing glycol fluid 13, 13a, 13b and/or 13c discharged from the contactor may also contain solids which form as a precipitate in the contactor 5, 5a, 5b and/or 5c. In this embodiment the spent deicing glycol fluid would contain dissolved and/or suspended solids which precipitate or agglomerate as a result of the concentrating effect of vaporization in the contactor 5, 5a, 5b and/or 5c. The generation of the solids and subsequent presence in the contactor discharge 13, 13a, 13b and/or 13c could provide a beneficial embodiment through the provision of a low temperature method for crystallization or solids formation. These solids could have commercial value or their formation and extraction could improve the quality of the deicing glycol fluid in process. In this embodiment the contactor discharge 13, 13a, 13b and/or 13c would include a method for removal of the solids from the contactor discharge 13, 13a, 13b and/or 13c.

The partial and fully reconstituted glycol bleeds 14, 14a, 14b and/or 14c, in a different embodiment, could be removed directly from the respective contactor 5, 5a, 5b and/or 5c or at any point prior to the introduction of the aqueous glycol feed 22, 22a, 22b and/or 22c. The actual control of the dehydrated glycol bleed rate in the present embodiment is through mechanism 15, 15a, 15b and/or 15c.

In other embodiments of the invention the dilute deicing glycol fluid inlet feed 22, 22a, 22b and/or 22c may be introduced into the process at any point prior to the contactor 5, 5a, 5b and/or 5c. The defining parameters for introduction points relate to the dilute deicing glycol 22, 22a, 22b and/or 22c feed pressure, the presence and performance parameters of the heat exchanger 20, 20a, 20b and/or 20c the presence and performance of the circulating pump 19, 19a, 19b and/or 19c or physical constraints of the installation site.

After the deicing fluid fluid 12, 12a, 12b and/or 12c contacts the airstream 3, 3a, 3b and/or 3c all or a percentage of it is recirculated for recontact. The driving force for this recirculation is through the pumping mechanism 19, 19a, 19b and/or 19c. In other embodiments this pumping mechanism can be located in other locations in the process depending on dilute deicing glycol fluid feed 22, 22a, 22b and/or 22c pressure and location, heat exchanger 20, 20a, 20b and/or 20c performance parameters and location, required reconstituted deicing glycol fluid bleed 14, 14a, 14b and/or 14c pressure requirements and physical constraints of the installation site.

Heat exchanger 20, 20a, 20b and/or 20c provides thermal energy to the deicing fluid glycol fluid 18, 18a, 18b and/or 18c in the invention process. In those embodiments in which heat exchanger 2, 2a, 2b and/or 2c is being utilized, the presence of heat exchanger 20, 20a, 20b and/or 20c, respectively, is optional. In other embodiments in which heat exchanger 20, 20a, 20b and/or 20c is utilized, the heat exchanger may be located in a multitude of locations in the dilute deicing glycol fluid streams 12, 13, 17, 18 relative to heat exchanger 20; streams 12a, 13a, 17a, 18a relative to heat exchanger 20a; streams 12b, 13b, 17b, 18b relative to heat exchanger 20b; streams 12c, 13c, 17c, 18c relative to heat exchanger 20c, as well as on the respective dilute deicing glycol fluid feed stream 22, 22a, 22b and/or 22c. An embodiment which utilizes a multitude of heat exchangers is also possible where the heat exchangers would be placed at various locations on the streams 12, 12a, 12b, 12c, 13, 13a, 13b, 13c, 17, 17a, 17b, 17c, 18a, 18b, 18c, 22a, 22b and/or 22c.

The following are claimed:

1. A low temperature dehydration process for the reconstitution of aqueous diluted glycol bearing deicing fluids inside a contacting chamber, the steps comprising:
Introducing an airstream into and through the contacting chamber;
introducing the aqueous diluted, glycol based deicing fluid into the contacting chamber;
introducing and contacting the aqueous diluted, glycol bearing, deicing fluid with the airstream in the contacting chamber;
removing a humidified airstream from the contacting chamber;
removing a dehydrated, reconstituted, glycol bearing deicing fluid from the contacting chamber for further use:

2. The process as described in claim 1 further including a step of warming the aqueous diluted, glycol bearing, deicing fluid prior to introducing the aqueous diluted, glycol bearing, deicing fluid into the contacting chamber.

3. The process as described in claim 1 further including a step of warming the airstream prior to introducing the airstream into the contacting chamber.

4. The process as described in claim 1 further including the step dehumidifying the airstream prior to introducing the airstream into the contacting chamber.

5. The process as described in claim 1 further including the step of reintroducing the dehydrated, reconstituted, glycol bearing deicing fluid back into the contacting chamber for further reconstitution by further dehydration.

6. The process as described in claim 1 further including the step blending a portion of the dehydrated, reconstituted, glycol bearing deicing fluid removed from the contacting chamber with the aqueous diluted, glycol bearing, deicing fluid introduced into the contacting chamber.

7. The process as described in claim 1 further including the step of contacting the airstream and the aqueous diluted, glycol bearing deicing fluid upon a heated surface within the contacting chamber.

8. The process as described in claim 1 wherein the glycol bearing fluid is not employed for deicing.

9. A low temperature dehydration process for the reconstitution of aqueous diluted glycol bearing deicing fluids inside a multiple, sequential series of contacting chambers, the steps comprising:
Introducing airstreams into and through multiple contacting chambers;
introducing the aqueous diluted, glycol based deicing fluid into the first contacting chamber;
introducing and contacting the aqueous diluted, glycol bearing, deicing fluid with the airstream in the first contacting chamber;
removing a partially dehydrated, partially reconstituted, glycol bearing deicing fluid from the first contacting chamber;
Introducing the partially dehydrated, partially reconstituted, glycol bearing deicing fluid into the second contacting chamber;
introducing and contacting the partially dehydrated, partially reconstituted, glycol bearing deicing fluid with the airstream in the second contacting chamber;
removing a dehydrated, reconstituted, glycol bearing deicing fluid from the second contacting chamber for further use;
removing humidified airstreams from the contacting chambers;

10. The process as described in claim 9 further including a step of warming the glycol bearing deicing fluid prior to introduction into the respective contacting chamber.

11. The process as described in claim 9 further including a step of warming an airstream prior to introducing said airstream into the respective contacting chamber.

12. The process as described in claim 9 further including the step of dehumidifying an airstream prior to introducing said airstream into the respective contacting chamber.

13. The process as described in claim 9 further including the step of reintroducing the glycol bearing deicing fluid removed from a contacting chamber back into said contacting chamber for further reconstitution by further dehydration.

14. The process as described in claim 9 further including the step of blending a portion of the glycol bearing deicing fluid removed from a contacting chamber with the more aqueous diluted, glycol bearing, deicing fluid introduced into said contacting chamber.

15. The process as described in claim 9 further including the step of contacting the introduced airstream and the introduced glycol bearing fluid upon a heated surface within the respective contacting chamber.

16. The process as described in claim 9 wherein the glycol bearing fluid is not employed for deicing.

17. A low temperature dehydration process for the reconstitution of aqueous diluted glycol bearing deicing fluids inside a multiple, sequential series of contacting chambers, the steps comprising:
Introducing airstreams into and through a series of contacting chambers;
introducing the aqueous diluted, glycol based deicing fluid into the first of the series of contacting chambers;
introducing and contacting the glycol bearing, deicing fluid introduced into the first contacting chamber or with the airstream also introduced into the first contacting chamber;
removing the partially dehydrated, partially reconstituted, glycol bearing deicing fluid from first contacting chamber and introducing said fluid sequentially into the next contacting chamber;
introducing and contacting the glycol bearing, deicing fluid introduced into said next contacting chamber with the airstream also introduced into said next contacting chamber;
removing the partially dehydrated, partially reconstituted, glycol bearing deicing fluid from said next contacting chamber and introducing said fluid sequentially into the next contacting chamber;
continuing this sequential process until removal of the glycol bearing fluid from the last contacting chamber can be provided as reconstituted, glycol bearing fluid for further use.

18. The process as described in claim 17 further including a step of warming the glycol bearing deicing fluid prior to introduction into the respective contacting chamber.

19. The process as described in claim 17 further including a step of warming an airstream prior to introducing said airstream into the respective contacting chamber.

20. The process as described in claim 17 further including the step of dehumidifying an airstream prior to introducing said airstream into the respective contacting chamber.

21. The process as described in claim 17 further including the step of reintroducing the glycol bearing deicing fluid removed from a contacting chamber back into said contacting chamber for further reconstitution by further dehydration.

22. The process as described in claim 17 further including the step of blending a portion of the glycol bearing deicing fluid removed from a contacting chamber with the more aqueous diluted, glycol bearing, deicing fluid introduced into said contacting chamber.

23. The process as described in claim 17 further including the step of contacting the introduced airstream and the introduced glycol bearing fluid upon a heated surface within the respective contacting chamber.

24. The process as described in claim 17 wherein the glycol bearing fluid is not employed for deicing.
